(19) United States
(12) Patent Application Publication
(10) Pub. No.: US 2009/0151229 A1
(43) Pub. Date: Jun. 18, 2009

(54) CARBON DIOXIDE RECOVERY FROM BIOFUELS PROCESSES FOR THE PRODUCTION OF UREA

(75) Inventor: Jerry M. Rovner, Houston, TX (US)

Correspondence Address: CHEVRON SERVICES COMPANY;LAW, INTELLECTUAL PROPERTY GROUP, P.O. BOX 4368, HOUSTON, TX, 77210-4368, US

(73) Assignee: Chevron U.S.A. Inc., San Ramon, CA (US)

(21) Appl. No.: 11/955,106

(22) Filed: Dec. 12, 2007

(51) Int. Cl. C10L 1/10; C05F 11/00; B01J 19/00

(52) U.S. Cl. 44/300; 71/23; 71/64.03; 422/189; 422/187

(57) ABSTRACT

The present invention is generally directed to systems and methods for processing biomass for the production of biofuels, wherein carbon dioxide (CO₂) produced as a by-product of such processing is reacted with ammonia (NH₃) to produce urea (NH₂)₂CO, a common agricultural fertilizer. In some such embodiments, the urea so produced can be used as fertilizer for biomass production, such biomass ultimately being channeled back into the systems/methods for conversion to biofuels.

### FIELD OF THE INVENTION

This invention relates generally to biofuels production, and specifically to methods and systems for utilizing carbon dioxide (CO₂), produced during biofuels processing, in the production of urea—a common agricultural fertilizer.

### BACKGROUND

Transportation fuels derived from biological sources (i.e., “biofuels”) have been gaining attention of late for at least two reasons: (1) rising oil prices have made biofuels economically-viable, and (2) the biological (i.e., photosynthetic) processes inherent to biomass production and cultivation at; least partially offset the carbon dioxide (CO₂) emissions generated by the combustion of the biofuels. As such, biofuels are generally seen as being “green” or “environmentally-friendly.” See, e.g., Pearce, “Fuels Gold,” New Scientist, 23 September, pp. 36-41, 2006.

A factor which partially-diminishes the green attributes of biofuels is that many of the processes that generate biofuels from biomass often produce CO₂ as a by-product. Accordingly, methods for utilizing the by-produced CO₂ in such a way that it does not contribute to the atmospheric greenhouse gas count, would be extremely beneficial.

### BRIEF DESCRIPTION OF THE INVENTION

The present invention is generally directed to systems and methods for processing biomass for the production of biofuels, wherein carbon dioxide (CO₂), produced as a by-product of such processing, is reacted with ammonia (NH₃) to produce urea, (NH₂)₂CO, a common agricultural fertilizer. In some such embodiments, the urea so produced can be used as fertilizer for biomass production, such biomass ultimately being channeled back into the systems/methods for conversion to biofuels.

In some embodiments, the present invention is directed to one or more methods comprising the steps of: (a) processing a quantity of biomass such that at least a portion of said biomass is converted into a quantity of at least one biofuel, wherein CO₂ is a by-product of said processing; (b) directing at least some of the by-product CO₂ into a reaction chamber where it is reacted with NH₃ to produce urea (and water); (c) utilizing the urea so produced to fertilize crops so as to yield a harvestable quantity of fertilized crops; (d) optionally harvesting at least some of the harvestable quantity of fertilized crops to yield a quantity of harvested crops; and (e) further optionally channeling at least some of the harvested crops back into said method as biomass. In some such embodiments, there further comprises an optional step of directing water, produced via the production of the urea, to the crops for purposes of cultivation.

In some embodiments, the present invention is directed to one or more systems comprising: (1) a processing subsystem for processing biomass into biofuel, wherein said processing produces CO₂ as a by-product; (2) a reactor subsystem for directing at least some of the by-product CO₂ into a reaction chamber where it is reacted with NH₃ to produce urea and H₂O; and (3) a fertilizing subsystem for fertilizing crops with the urea so produced. In some such system embodiments, such systems may further comprise an irrigation subsystem for directing at least some of the H₂O produced in the reactor subsystem to crops for cultivation purposes. Such systems may further comprise a harvesting subsystem for harvesting the crops for use as biomass in the processing subsystem.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts, in stepwise fashion, a method for processing biomass into biofuels, wherein CO₂ produced as a by-product is reacted with NH₃ to form urea, in accordance with some embodiments of the present invention; and

FIG. 2 illustrates, in flow diagram form, a system for implementing the method depicted in FIG. 1.

### DETAILED DESCRIPTION OF THE INVENTION

### 1. Introduction

The present invention is an extension of existing processes and systems that convert biomass to biofuels and generate carbon dioxide (CO₂) while doing so. In methods (processes) and systems of the present invention, CO₂ (generated via the processing of biomass) is reacted with ammonia (NH₃) to yield urea and water. Additionally, the urea can be used to fertilize crops for use as biomass in such methods and systems, and the water produced can be used to irrigate said crops. Advantageously, the methods and systems of the present invention reduce CO₂ contributions to the atmosphere, while still providing all of the traditional benefits biofuels can offer.

### 2. Definitions

Certain terms and phrases are defined throughout this description as they are first used, while certain other terms used in this description are defined below:

“Biomass,” as defined herein, refers to biologically-derived material (e.g., plants and crops), particularly wherein such material can be processed in such a way as to make biofuel. Biomass can comprise one or more of the following: cellulose, carbohydrates (including simple sugars and polysaccharides), hemicellulose, lignin, triglycerides, and starch.

“Agricultural crops,” as defined herein, refer to a plurality or collection of harvestable plants that provide for an economically-demonstrated need (e.g., food), said collection generally comprising a single type of species for a given crop. Examples of such agricultural crops include, but are not limited to, corn, maize, rice, wheat, sugar cane, and the like.

“Cultivation,” as defined herein, refers to the process(es) of growing the agricultural crops, wherein they are provided sunlight, water, nourishment, etc., until such time as they are ripe for harvesting.

“Harvesting,” as defined herein, refers to the process or processes by which an agricultural crop (or generally any crop) is collected in anticipation of further processing and/or distribution as food or other products (e.g., biofuels).

“Biofuels,” as defined herein, are fuels wherein at least about 10 percent by weight of said fuel is derived from a non-fossil-fuel biological source (e.g., biomass). Typically, such biofuels are transportation fuels, i.e., they are operable for use in vehicular engines.

### 3. Methods

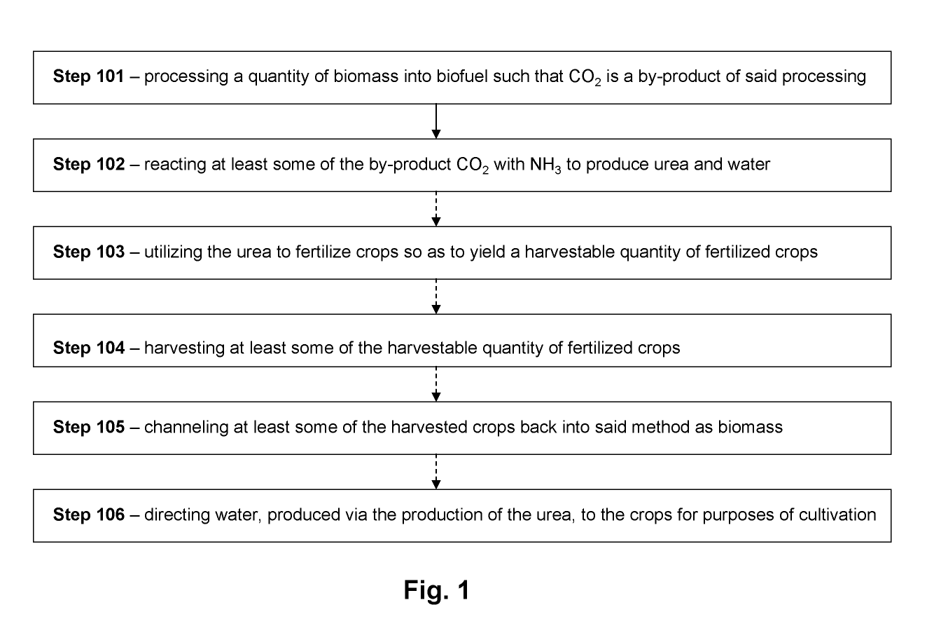

As mentioned previously, and with reference to FIG. 1, in some embodiments the present invention is directed to at least one method comprising the steps of: (Step 101) processing a quantity of biomass such that at least a portion of said biomass is converted into a quantity of at least one biofuel, wherein CO₂ is a by-product of said processing; (Step 102) directing at least some of the by-product CO₂ into a reaction chamber where it is reacted with NH₃ to produce urea; and (Step 103) utilizing the urea so produced to fertilize crops so as to yield a harvestable quantity of fertilized crops. In some embodiments, such methods may further comprise the steps of: (Step 104) harvesting at least some of the harvestable quantity of fertilized crops to yield a quantity of harvested crops; and (Step 105) channeling at least some of the harvested crops back into said method as biomass. In some or other embodiments, such methods may further comprise a step (Step 106) of directing water, produced via the production of the urea, to the crops for purposes of cultivation.

In some such above-described method embodiments, the urea is processed into granules to facilitate its use as a fertilizer. Such granulization and/or pelletization processes are well known to those of skill in the art and can be readily practiced, particularly since urea is already an established fertilizer.

In some such above-described method embodiments, the CO₂ is compressed prior to reaction with the NH₃. Compression of CO₂ increases its concentration in the reaction chamber, and it correspondingly enhances the efficiency with which the CO₂ reacts with NH₃. Note that such compression techniques, together with reaction conditions and reaction chamber environment, are well known to those of skill in the art, and that the variability in these aspects falls within the scope of the presently-claimed invention.

In some such above-described method embodiments, the step of processing a quantity of biomass comprises a process technique selected from the group consisting of fermentation, gasification, aqueous reforming, and combinations thereof. Those of skill in the art will recognize, however, that any process technique for converting biomass to biofuel, with CO₂ being produced as a by-product, could be used in lieu of, or in addition to, any of the aforementioned techniques. Detailed descriptions of such techniques are readily available in the literature, but an adequate review can be found in Huber et al., “Synthesis of Transportation Fuels from Biomass: Chemistry, Catalysts, and Engineering,” Chem. Rev., vol. 106, pp. 4044-4098, 2006.

In some such above-described method embodiments, the biomass is generated from agricultural crops. However, those of skill in the art will recognize that there is tremendous flexibility in the source(s) of biomass—provided that they are compatible with the above-mentioned processing technique that affords CO₂ as a by-product.

In some such above-described method embodiments, at least a portion of the at least one biofuel produced is operable for use as a transportation fuel (e.g., diesel, jet fuel, E85, etc.). In these or other embodiments, the at least one biofuel produced comprises molecular species selected from the group consisting of alcohols, esters, alkanes, and combinations thereof.

In some such above-described method embodiments, there further comprises a step of directing a portion of the CO₂ produced to the crops for purposes of cultivation. Such a step could be intermittently employed to adjust and/or compensate for fluctuations in feed supply and/or product output.

### 4. Systems

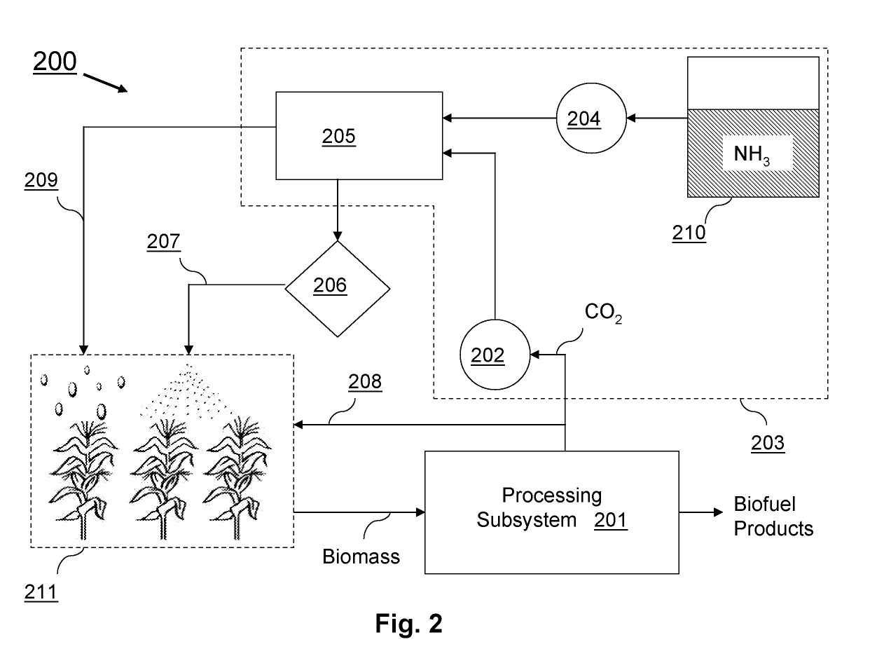

As already mentioned in a previous section, and with reference to FIG. 2, in alternate embodiments the present invention is directed to at least one system 200 comprising: a processing subsystem 201 for processing biomass into biofuel, wherein said processing produces CO₂ as a by-product; a reactor subsystem 203 for directing at least some of the by-product CO₂ into a reaction chamber 205 where it is reacted with NH₃ (from NH₃ source 210) to produce urea and H₂O; and a fertilizing subsystem 207 for fertilizing crops with the urea so produced. In some such embodiments, the at least one system may further comprise an irrigation subsystem 209 for directing at least some of the H₂O produced in the reactor subsystem 203 to crops for cultivation purposes.

Still referring to FIG. 2, in some such above-described system embodiments, the at least one system may further comprise a harvesting subsystem 211 for harvesting the crops for use as biomass in the processing subsystem 201. Such a harvesting subsystem can comprise a variety of apparatuses and techniques well-known to those in the agricultural community.

In some such above-described system embodiments, the at least one system may further comprise one or more of any number of subsystem elements such as, but not limited to, a compressor 202 for compressing CO₂ prior to its introduction into the reactor subsystem 203, a pump 204 for introducing the NH₃ into the reactor subsystem, a means 206 for granulizing the urea prior to using it as a fertilizer, and a means 208 for delivering at least a portion of the CO₂ produced to the crops for purposes of cultivation. Again, such elements are well-established in the art.

In some such above-described system embodiments, the processing subsystem involves a processing technique such as, but not limited to, fermentation, gasification, pyrolysis, aqueous reforming, and the like. Such processing subsystems are not particularly limited provided that they provide for by-product CO₂. Such processing subsystems correspond directly with the processing techniques described above in Section 3.

Generally speaking, such above-described system embodiments are contemplated for operably carrying out or implementing the method embodiments described in Section 3 (see above).

### 5. Integrated Processes and Systems

As already alluded to, an attractive feature of the present invention is its enhancement (relative to existing processes and systems) with regard to process self-sustainability. With regard to the production of biofuels from biomass, all of the elements are regenerated save sunlight (required for photosynthesis) and NH₃, although it is likely that additional sources of water will be required for irrigation purposes.

While logistically it may be preferred to locate elements of the methods/systems of the present invention within close proximity of each other, this need not be the case. Supply channels can be established and modified as needed, the logistics of which will be appreciated by those of skill in the art.

### 6. Examples

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### Example 1

This Example serves to illustrate how a fermentation process can be integrated into the methods and systems of the present invention.

Starch, extracted from agricultural crops (e.g., potatoes or maize) and being a type of biomass, can be processed into ethanol by fermentation techniques. This fermentation can be described chemically as follows:

C₆H₁₀O₅+[anaerobic respiration]→2C₂H₅OH+2CO₂

While the ethanol (C₂H₅OH) produced is further processed into a biofuel (e.g., E85), the CO₂ is reacted with NH₃ to yield urea and water—both of which can be used to cultivate the production of more agricultural crops from which starch can be extracted and fed back into the process.

### Example 2

This Example serves to illustrate how aqueous reforming can be integrated into the methods and systems of the present invention.

Sugars, such as glucose, can be processed into alkanes via aqueous reforming. This aqueous reforming can be described chemically as follows:

C₆H₁₂O₆(s)→(12/19)C₂H₅(g)+(42/19)CO₂(g)+(30/19)H₂O(g)

Glucose is typically produced via the enzymatic hydrolysis of starch. Being analogous to the scenario put forth in EXAMPLE 1, a starch-yielding agricultural crop is harvested, processed to extract starch and hydrolyze said starch to glucose, then converting the glucose to alkanes via the above reaction. Such alkanes can be used as a biofuel directly, or they can be further processed.

### Example 3

This Example serves to illustrate the type of symbiotic relationship that can be established between systems/methods of the present invention and existing ammonia plants.

Urea is produced commercially via the following reaction:

CO₂+2NH₃→(NH₂)₂CO+H₂O

Many ammonia plants also co-produce urea. However, considering the overall reaction:

1.177CH₄+1.333N₂+1.646H₂O→2.667NH₃+1.177CO₂

with a CO₂:NH₃ ratio of 0.44, some such ammonia plants may be short of CO₂ in the required 0.5 ratio to ammonia (depending on the amounts of higher alkanes in the natural gas from which the NH₃ is made). Accordingly, there should be a merchant market for this excess liquid ammonia which could be transported by truck or rail car to a storage tank at biofuels production facility.

### 7. Conclusion

In summary, the present invention is generally directed to systems and methods for processing biomass for the production of biofuels, wherein CO₂ produced as a by-product of such processing is reacted with NH₃ to produce urea, a common agricultural fertilizer. In some such embodiments, the urea so produced can be used as fertilizer for biomass production, such biomass ultimately being channeled back into the systems/methods for conversion to biofuels.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed:

1. A method comprising the steps of:
a) processing a quantity of biomass such that at least a portion of said biomass is converted into a quantity of at least one biofuel, wherein CO₂ is a by-product of said processing; and
b) directing at least some of the by-product CO₂ into a reaction chamber where it is reacted with NH₃ to produce urea.

2. The method of claim 1, further comprising the step of utilizing the urea so produced to fertilize crops so as to yield a harvestable quantity of fertilized crops.

3. The method of claim 2, further comprising the steps of:
a) harvesting at least some of the harvestable quantity of fertilized crops to yield a quantity of harvested crops; and
b) channeling at least some of the harvested crops back into said method as biomass.

4. The method of claim 3, further comprising a step of directing water, produced via the production of the urea, to the crops for purposes of cultivation.

5. The method of claim 2, wherein the urea is processed into granules to facilitate its use as a fertilizer.

6. The method of claim 2, wherein the CO₂ is compressed prior to reaction with the NH₃.

7. The method of claim 2, wherein the step of processing a quantity of biomass comprises a process technique selected from the group consisting of fermentation, gasification, aqueous reforming, and combinations thereof.

8. The method of claim 2, wherein the biomass is generated from agricultural crops.

9. The method of claim 2, wherein at least a portion of the at least one biofuel produced is operable for use as a transportation fuel.

10. The method of claim 2, wherein the at least one biofuel produced comprises molecular species selected from the group consisting of alcohols, esters, alkanes, and combinations thereof.

11. The method of claim 4, further comprising a step of directing a portion of the CO₂ produced to the crops for purposes of cultivation.

12. A system comprising:
a) a processing subsystem for processing biomass into biofuel, wherein said processing produces CO₂ as a by-product; and
b) a reactor subsystem for directing at least some of the by-product CO₂ into a reaction chamber where it is reacted with NH₃ to produce urea and H₂O.

13. The system of claim 12, further comprising a fertilizing subsystem for fertilizing crops with the urea so produced.

14. The system of claim 13, further comprising an irrigation subsystem for directing at least some of the H₂O produced in the reactor subsystem to crops for cultivation purposes.

15. The system of claim 14, further comprising a harvesting subsystem for harvesting the crops for use as biomass in the processing subsystem.

16. The system of claim 15, further comprising a compressor for compressing CO₂ prior to its introduction into the reactor subsystem.

17. The system of claim 15, further comprising a pump for introducing the NH₃ into the reactor subsystem.

18. The system of claim 15, further comprising a means for granulizing the urea prior to using it as a fertilizer.

19. The system of claim 15, further comprising a means for delivering at least a portion of the CO₂ produced to the crops for purposes of cultivation.

20. The system of claim 13, wherein the processing subsystem employs a processing technique selected from the group consisting of fermentation, gasification, aqueous reforming, and combinations thereof.
